(19) United States
(12) Patent Application Publication
(10) Pub. No.: US 2009/0221189 A1
(43) Pub. Date: Sep. 3, 2009

(54) Press-contacting conductive terminal device

(76) Inventor: Xiang Xu, Jiangsu (CN)

Correspondence Address: Stephen Z Weiss;Molex Incorporated, 2222 Wellington Court, Lisle, IL, 60532, US

(21) Appl. No.: 10/582,904

(22) PCT Filed: Jan. 10, 2005
(86) PCT No.: PCT/US05/00695

§ 371 Date: May 4, 2009

(30) Foreign Application Priority Data
Jan. 9, 2004 (CN) 04 2 0001514.0

(51) Int. Cl. H01R 13/24

(52) U.S. Cl. 439/700

(57) ABSTRACT

A press-contacting conductive terminal device comprises a non-conductive enclosure, a base, a contact member and a resilient member. The non-conductive enclosure defines a cylindrically shaped through hole. A front end and a rear end of the through hole having a first opening and a second opening, respectively. The contact member having a front end portion and a rear end portion, the rear end portion of the contact member and the resilient member being received in the through hole. One end of the resilient member abutting against the rear end portion of the contact member and the front end portion of the contact member extending through the first opening and beyond a front end of the non-conductive enclosure. The base including two side wings and a base portion, the base closing the second opening of the rear end of the through hole. The rear end of the contact member being set between the two side wings of the base and the outer wall of the rear end of the contact member sliding within the inner walls and the two side wings. Thereby, the assembled press-contacting conductive terminal device omits the need for the previous metal shell, saving material, reducing weight, and saving cost.

### FIELD OF THE INVENTION

The present invention relates to a press-contacting conductive terminal device and particularly to a device which can be used as a test probe or used for electrically connecting two devices together. To save material and to reduce its weight and cost, a metal shell completely enclosing the contact member moving chamber is eliminated.

### BACKGROUND OF THE INVENTION

Referring to FIG. 1, a known press-contacting conductive terminal can be used as a test probe or used for electrically connecting two devices together. The press-contacting conductive terminal comprises a shell 10a, a contact member 20a and a resilient member 30a. The shell 10a is integrally molded with metal material into a hollow cylinder. The front end of the shell 10a is open and the rear end of the shell 10a is closed. The contact member 20a is also made of a conductive material. The resilient member 30a and the contact member 20a are inserted into the shell 10a from the front end of the shell 10a. Thereafter, the front end of the shell 10a is riveted to form a rather small opening 11a. The contact member 20a and the resilient member 30a are thereby held in the shell 10a because of the rather small opening 11a. The front end of the contact member 20a extends through the opening 11a and beyond the front end of the shell 10a due to the force of the resilient member 30a.

The above-mentioned press-contacting conductive terminal may be inserted a through hole 41a (see FIG. 2) of a non-conductive enclosure 40a. Additionally, a pair of press-contacting conductive terminals are generally inserted into two corresponding through holes 41a (see FIG. 3) of the non-conductive enclosure 40a side by side so as to transmit both negative and positive power.

In a practical use, the rear end of the shell 10a may be fixed to and electrically connected directly to a surface of a circuit board or by a through hole. Both the front end of the contact member 20a and the rear end of shell 10a may be contacted to transmit a signal between the two points. However, for the known press-contacting conductive terminal, a large amount of metal material is needed to provide the cylindrical metal shell 10a. Also, the metal shell 10a is rather heavy. Furthermore, the front end of the shell 10a needs to be riveted, which takes much time and energy, and must be performed carefully to ensure that the diameter of opening 11a is within tolerances after riveting. If the diameter of the opening 11a is too large, the contact member 20a is easily swayed. If the diameter is too small, the movement of contact member 20a may be blocked.

Accordingly, as shown above, the known press-contacting conductive terminal devices are in need of improvement to reduce cost. The inventors believe that the invention presented below will provide this improvement.

### SUMMARY OF THE INVENTION

A main object of the present invention is to provide a press-contacting conductive terminal device, which can omit a cylindrical metal shell of the known technology, and uses an inner wall of a through hole of a non-conductive enclosure to partially replace the metal shell. By omitting the metal shell, there will be a saving of material, a reduction of weight, and a reduction in cost. Also additional electrical contact is made between the movable contact member and the two side wings extending within the contact chamber. Another object of the present invention is to provide a press-contacting conductive terminal device, wherein an opening may be formed in the non-conductive enclosure where the aperture diameter of the opening is easily controlled.

To fulfill the above-mentioned objects, the present invention provides a press-contacting conductive terminal device including a non-conductive enclosure defining a cylindrically shaped through hole where the front end and a rear end of the through holes have a first opening and a second opening, respectively. At least one contact member is received in the cylindrically shaped through hole. The contact member has a front end portion and a rear end portion. The outside diameter of the rear end portion is slightly larger than the outside diameter of the front end portion which keeps the contact member from passing out of the front end of the through hole. At least one resilient member is received in the through hole with one end abutting and placing a force against the rear end portion of the contact member. This force will cause the contact member to moveably extend though the first opening beyond the front end of the non-conductive enclosure. At least one base includes two side wings and a contact portion. The side wings extend together from the contact portion. The contact portion covers the second opening on the rear end of the through hole. The two side wings of the base partially form the inner walls of the cylindrical though hole.

### DESCRIPTION OF THE DRAWING

The technical means and effects used in this invention to realize the objects of the invention will be further described combining with the detailed descriptions and the accompanying drawings. But it is to be understood that the invention is not limited to the accompanying drawings.

FIG. 1 is a cross-sectional view of a known press-contacting conductive terminal (no non-conductive enclosure);

FIG. 2 is a whole cross-sectional view of a known press-contacting conductive terminal;

FIG. 3 is a whole cross-sectional view of a pair of known press-contacting conductive terminals;

FIG. 4 is an exploded perspective view of a press-contacting conductive terminal device of the present invention;

FIG. 5 is an assembled perspective view of a press-contacting conductive terminal device of the present invention;

FIG. 6 is an assembled perspective view of a press-contacting conductive terminal device of the present invention with another viewpoint;

FIG. 7 is a front view of a press-contacting conductive terminal device of the present invention;

FIG. 8 is a cross-sectional view along 8-8 of FIG. 7;

FIG. 9 is an exploded perspective view of a part of a press-contacting conductive terminal device of the present invention.

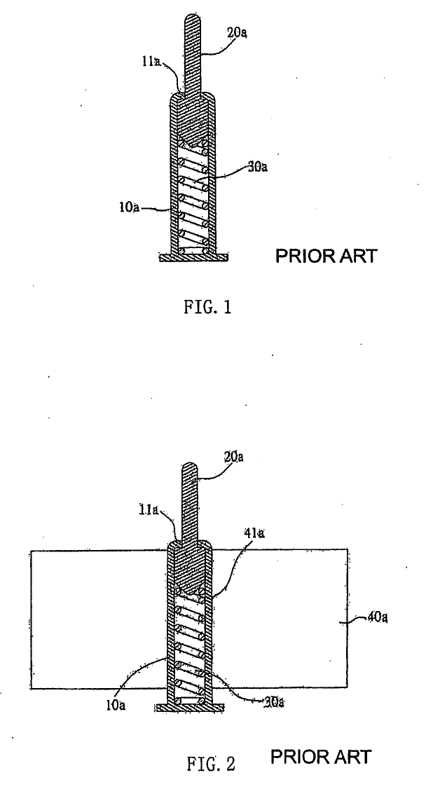

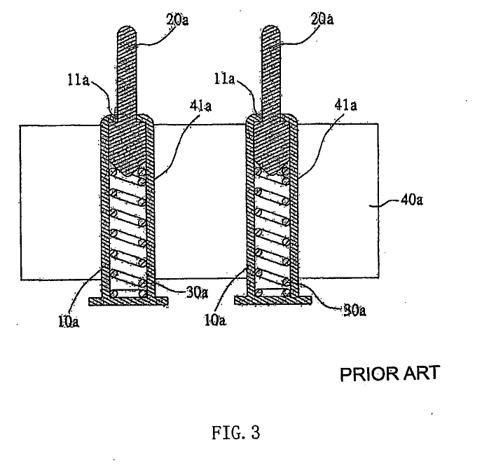

### DETAILED DESCRIPTION OF THE INVENTION

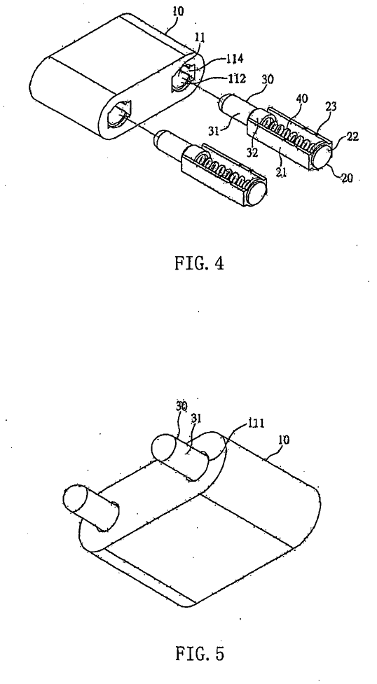

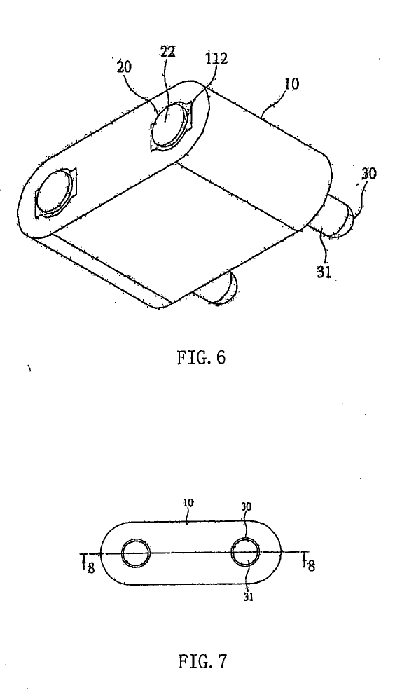

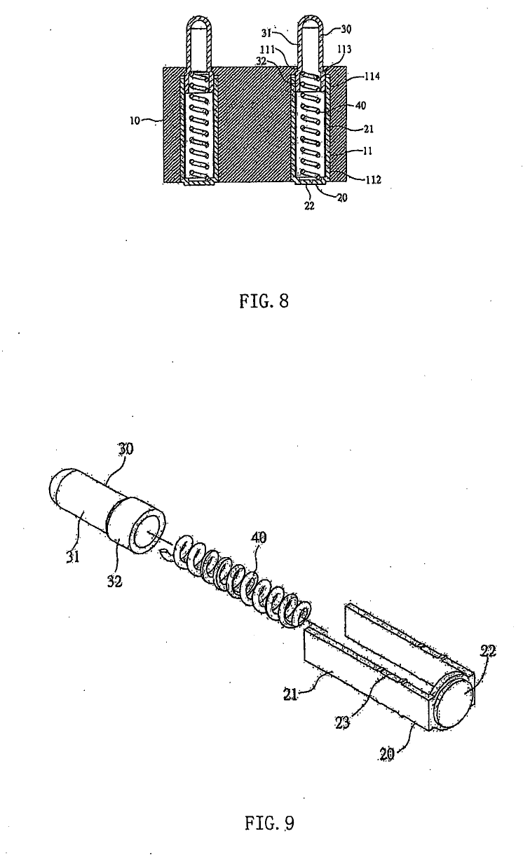

Referring to FIGS. 4 to 9, the present invention relates to a press-contacting conductive terminal device. The conductive terminal device comprises a non-conductive enclosure 10, at least one base 20, at least one contact member 30, and at least one resilient member 30. The non-conductive enclosure 10 defines at least one cylindrically shaped through hole 11. The through hole 11 extends from a front end through a rear end of the non-conductive enclosure 10. The through hole 11 has a first opening 111 at the front end of the non-conductive enclosure 10 and a second opening 112 at the rear end of the non-conductive enclosure 10. An inner diameter of the first opening 111 is less than that of the through hole 11. A stop portion 113 is thereby defined by the first opening 111 shrinking abruptly to prevent the rear end 32 of the contact member 30 from moving out of the through hole 11. The stop portion 113 is integrally formed with the non-conductive enclosure 10 at the front end of the non-conductive enclosure 10, so as to easily control the size of the aperture diameter of the first opening 111.

The contact member 30 is made of a metal material with good conductivity, and is received in the through hole 11. The contact member 30 is configured to be hollow or solid. The contact member 30 consists of a front end portion 31 whose outside diameter is less than the inside diameter of the first opening 111 and a rear end portion 32 whose outside diameter is larger than the inside diameter of the first opening 111 while less than the inside diameter of the through hole 11. This will allow the contact member 30 to freely move within the through hole 11 of the non-conductive enclosure 10. The rear end portion 32 of the contact member 30 is disposed in the through hole 11, and the front end portion 31 of the contact member 30 extends through the first opening 111 and beyond the front end of the non-conductive enclosure 10.

The resilient member 40 is a compressive spring, made of a conductive material, and is disposed in the through hole 11. One end of the resilient member 40 abuts against the inner portion of the contact member 30 and the other end of the resilient member 40 abuts against the contact portion 22 of the base 20. An electrical connection is made by this resilient member 40 engaging both the contact member 30 and the base 20. The resilient member pushes the front end portion 31 of the contact member 30 to resiliently extend beyond the front end of non-conductive enclosure 10.

The base 20, which is made of metal material with good conductivity, has two side wings 21 and a contact portion 22. The side wings 21 both integrally extend upwardly from the contact portion 22, and the side faces have a plurality of interfering portions 23, such as protrusions or barbs. Two inner slots 114 which correspond to the side wings 21 of the base 20 are defined at the second opening 112 of the non-conductive enclosure 10 and extend along the axial direction of the though hole 11. These inner slots 114 are located at two sides of the through hole 11. The two side wings 21 of the base 20 are inserted into the two inner slots 114 respectively, and are held in place with the interfering portions 23 embedded within the inner slots 114. The side wings 21 extend a suitable distance from the first opening 111 into the through hole to provide contact with the rear end 32 of the contact member 30 and the side wings 21 during the sliding movement of the contact member within the through hole.

During assembly, after the contact member 30 and the resilient member 40 are inserted into the through hole 11, the side wings 21 of the base 20 are aligned with the inner slots 114 and inserted into the through hole 11. Thereafter, the base 20 is assembled to the second opening 112 of the non-conductive enclosure 10 to close the second opening 112 of the rear end of the through hole 11. Since the resilient member 40 is located between the base 20 and the contact member 30, the front end portion 31 of the contact member 30 extends resiliently through the first opening 111 and beyond the front end of the non-conductive enclosure 10 due to the force of the resilient member 40. The rear end 32 of the contact member 30 is set between the two side wings 21 of the base 20 where the outer wall of the rear end 32 slides in continuous electrical contact with the inner walls of the two side wings 21 of the base 20. This makes the electric connection between the contact member 30 and the base 20. An electrical connection is also made between the contact member 30 and the base 20 by way of the conductive resilient member 40.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A press-contacting conductive terminal device, comprising:
a non-conductive enclosure (10) defining a cylindrically shaped through hole (11), a front end and a rear end of the through hole having a first opening (111) and a second opening (112), respectively,
at least one contact member (30) having a front end portion (31) and a rear end portion (32), an outside diameter of the rear end portion being slightly larger than an outside diameter of the front portion, the rear end portion being slideably received in the through hole;
at least one resilient member (40), being received in the through hole (11), one end thereof abutting against the rear end portion (32) of the contact member (30) and causing the front end portion (31) of the contact member to extend through the first opening (111) and beyond a front end of the non-conductive enclosure (10), a stop portion (113) placed on the first opening (111) of the non conductive enclosure to prevent the rear end (32) of the contact member from moving out of the through hole (11);
at least one base (20), including two side wings (21) and a contact portion (22), the side wings extending together from the contact portion (22) and having a planar surface a portion of which is tangent to an inner surface of the cylindrically shaped through hole (11), the contact portion (22) completely covering the second opening (112) on the rear end of the through hole (11) when the base is inserted into the rear end of the non conductive enclosure;
the rear end (32) of the contact member (30) located between the two side wings (21) of the base with an outer wall of the rear end (32) of the contact member (30) sliding in continuous electrical contact with an inner wall of the two side wings (21).

2. A press-contacting conductive terminal device as claimed in claim 1, wherein the stop portion (113) is integrally formed with the non-conductive enclosure.

3. A press-contacting conductive terminal device as claimed in claim 2 wherein the stop portion (113) is an inner diameter of the first opening (111) of the non conductive housing (10) being smaller than the outer diameter of the rear portion (32) of the contact member (30) while the outer diameter of the front portion (31) of the contact member is smaller than the inner diameter of the first opening.

4. A press-contacting conductive terminal device as claimed in claim 1, wherein the non-conductive enclosure (10) defines two slots (114), at two sides of the through hole, extending along an axial direction of the through hole, and adjacent to the second opening (112), each side wing (21) of the base (20) corresponding to and insertable into a respective inner slot (114).

5. A press-contacting conductive terminal device as claimed in claim 4, wherein two side wings (21) of the base (20) respectively form a plurality of interfering portions (23) to be interferingly engaged within the slots (114).

6. A press-contacting conductive terminal device as claimed in claim 1, wherein the two side wings (21) extend from the first opening (111) into the through hole a length at least as long as the rear end (32) of the contact member (30) slides within the through hole (11).

7. A press-contacting conductive terminal device as claimed in claim 1, wherein the resilient member (40) is a spring.
